(19) United States
(12) Patent Application Publication
(10) Pub. No.: US 2012/0126556 A1
(43) Pub. Date: May 24, 2012

(54) TWEEZERS

(75) Inventors: Kang Wu, Shenzhen City (CN); Bo Tian, Shenzhen City (CN); Xiao-Gang Yin, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/960,370

(22) Filed: Dec. 3, 2010

(30) Foreign Application Priority Data
Nov. 24, 2010 (CN) 201010557108.2

(51) Int. Cl. B25B 9/02

(52) U.S. Cl. 294/99.2

(57) ABSTRACT

A tweezers include two resilient levers, and two pincers respectively defining two receiving spaces. The two levers respectively engage in the two receiving spaces.

### BACKGROUND

1. Technical Field

The present disclosure relates to tweezers.

2. Description of Related Art

The pincers of tweezers generally become worn out after a lot of use. As a result, new tweezers are needed to replace the whole tweezers, which can become costly in a long run.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a tweezers.

FIG. 2 is an assembled, isometric view of the tweezers of FIG. 1.

FIG. 3 is an assembled, isometric view of another embodiment of a tweezers.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

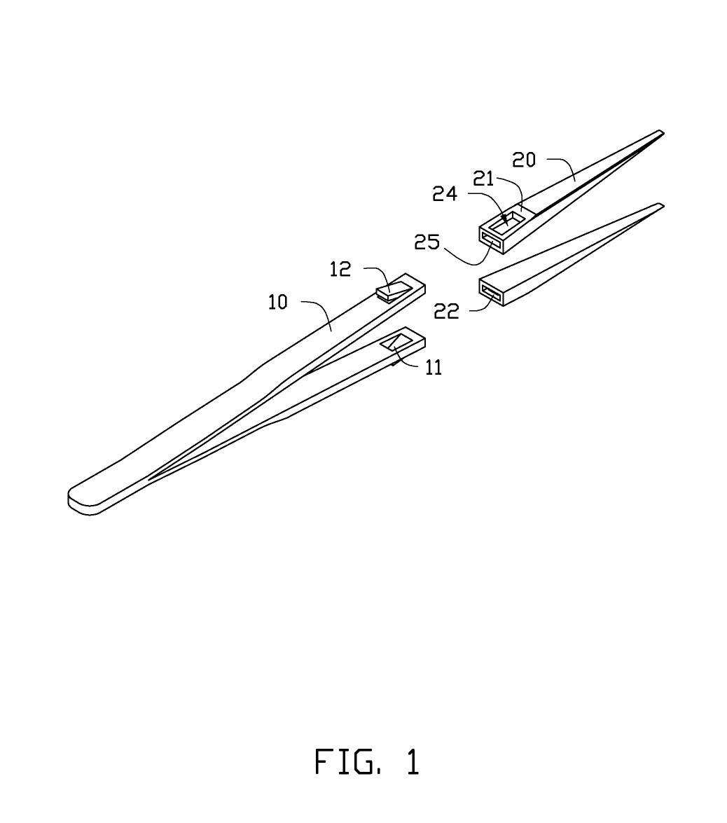

Referring to FIG. 1, an exemplary embodiment of a tweezers includes a main body with two resilient levers 10, and two pincers 20.

First ends of the levers 10 are connected together, with an angle defined between the levers 10 to make second ends of the levers 10 opposite to the first ends spaced from each other. A slot 11 is defined in the second end of each lever 10. A resilient tab 12 extends toward the first end of each lever 10 from a side bounding each slot 11 adjacent to the second end of the corresponding lever 10.

In this embodiment, a hollow and substantially rectangular shaped connection portion 21 extends from a first end of each pincer 20, and defines a receiving space 22 with an opening 25 of the receiving space 22 opposite to a second end of the corresponding pincer 20. A slot 24 is defined in a side of each connection portion 21, communicating with the corresponding receiving space 22.

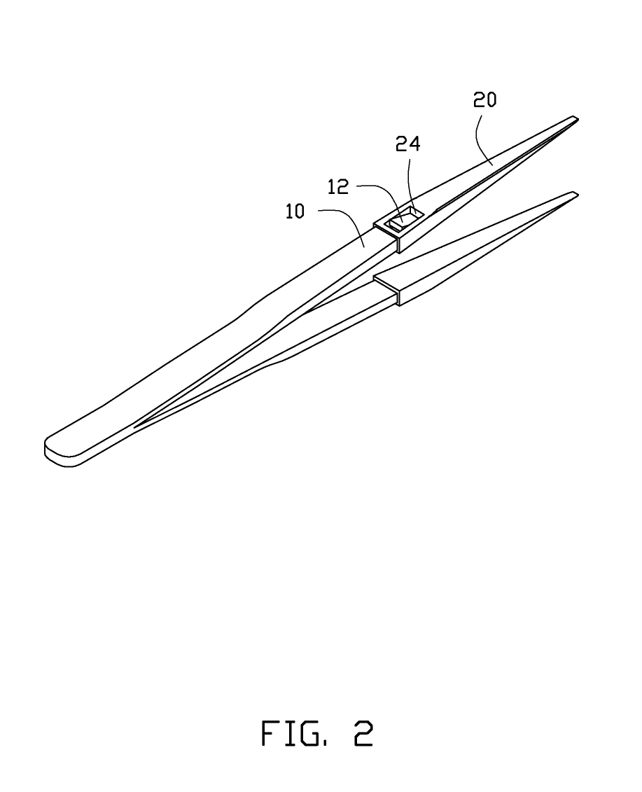

Referring to FIG. 2, in assembly, the second ends of the levers 10 enter the receiving spaces 22 through the openings 25 of the corresponding connection portions 21. The resilient tabs 12 engage in the corresponding slots 24, to fix the pincers 20 to the corresponding levers 10.

In disengagement of the pincers 20 from the corresponding levers 10, the resilient tabs 12 are pressed toward the corresponding receiving spaces 22 to withdraw in the receiving spaces 22, thereby readily disengaging from the corresponding receiving spaces 22. Thereby, the pincers 20 can be removed from the corresponding levers 10 easily.

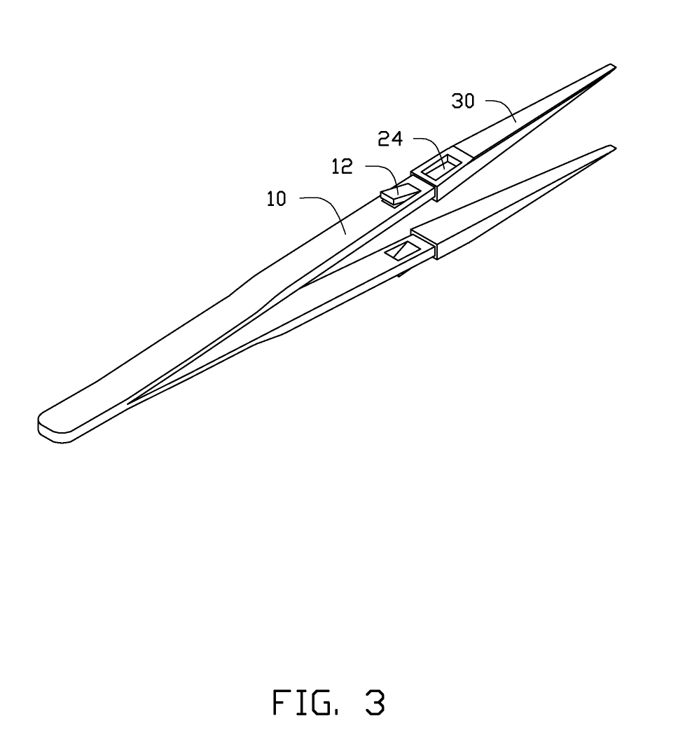

Referring to FIG. 3, in other embodiments, the tabs 12 and the slots 21 can be omitted, and the levers 10 may be engaged in two receiving spaces 22 of two pincers 30 tightly and directly.

Moreover, distal ends of the corresponding pincers 20 opposite to the corresponding connection portions 21 can be any shaped, such as cuspate, or hamulus-shaped.

It is believed that the present embodiments and their advantages will be understood from the foregoing description, and they will be apparent that various changes may be made thereto without departing from the spirit and scope of the description or sacrificing all of their material advantages, the examples hereinbefore described merely being exemplary embodiment.

What is claimed is:

1. A tweezers, comprising:
two resilient levers connected together by first ends of the levers, with an angle formed between the levers to make second ends of the levers opposite to the first ends space from each other; and
two pincers, each defining a receiving space in an end thereof;
wherein the second ends of the levers engage in the receiving spaces of the two pincers.

2. The tweezers of claim 1, wherein a connection portion extends from the end of each of the pincers, the receiving space is defined in the connection portion.

3. The tweezers of claim 2, wherein a first slot is defined in an out side sides of each connection portion and communicates with the corresponding receiving space, a resilient tab extends from the second end of each lever to engage in the corresponding first slot of the corresponding connection portion, in response to the second end of the lever entering the receiving space of the connection portion.

4. The tweezers of claim 3, wherein a second slot is defined in the second end of each of the levers; the resilient tab extends from a side bounding each of the second slots toward the first end of the lever.
